(19) United States
(12) Patent Application Publication
(10) Pub. No.: US 2007/0030343 A1
(43) Pub. Date: Feb. 8, 2007

(54) Interactive, video-based content for theaters

(76) Inventor: Mitchell M. Rohde, Saline, MI (US)

Correspondence Address: LAW OFFICES OF MICHAEL DRYJA, 704 228TH AVENUE NE, PMB 694, SAMMAMISH, WA, 98074, US

(21) Appl. No.: 11/460,981

(22) Filed: Jul. 29, 2006

Related U.S. Application Data
(60) Provisional application No. 60/705,746, filed on Aug. 6, 2005.

(51) Int. Cl. H04N 13/02

(52) U.S. Cl. 348/47; 348/153

(57) ABSTRACT

An interactive advertisement and entertainment system for public or private movie theaters (cinemas) or venues with large screens and an audience directly in front of, and viewing, the screens.

### RELATED APPLICATIONS

The present patent application claims the benefit of and priority to the previously filed provisional patent application entitled “Interactive, video-based content for theaters,” filed on Aug. 6, 2005, and assigned Ser. No. 60/705,746, and which is hereby incorporated by reference.

### BRIEF DESCRIPTION OF THE DRAWINGS

FIGS. 1-7 are diagrams depicting various aspect of differing embodiments of the invention.

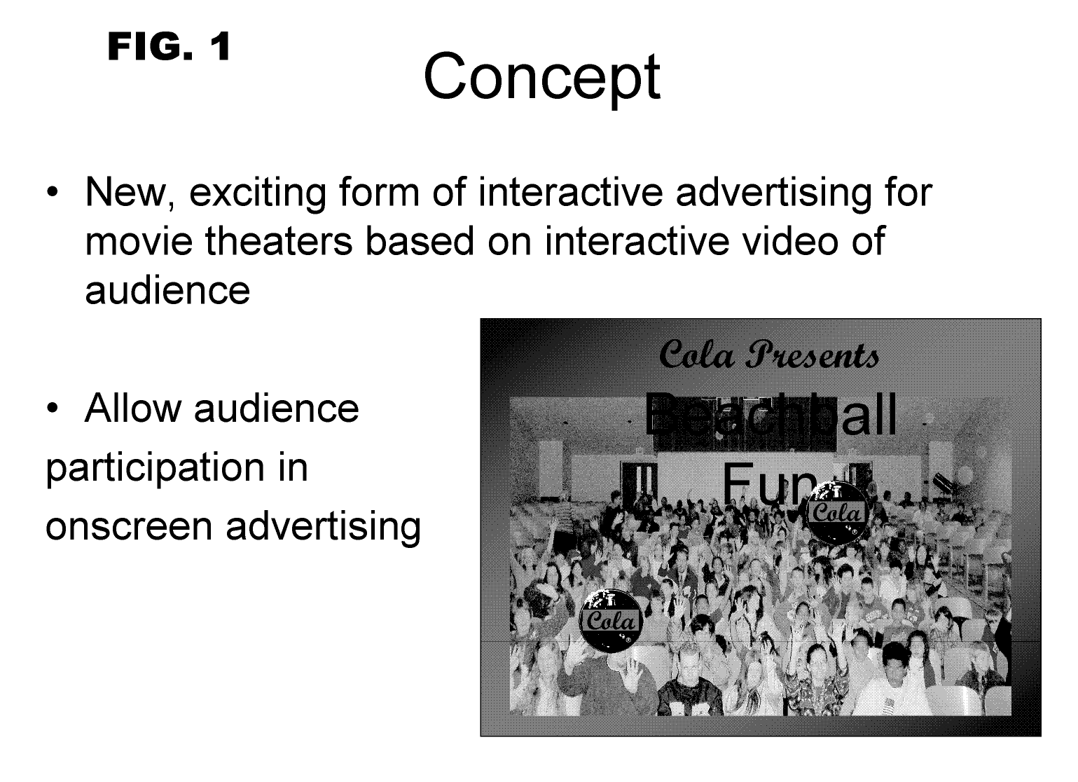

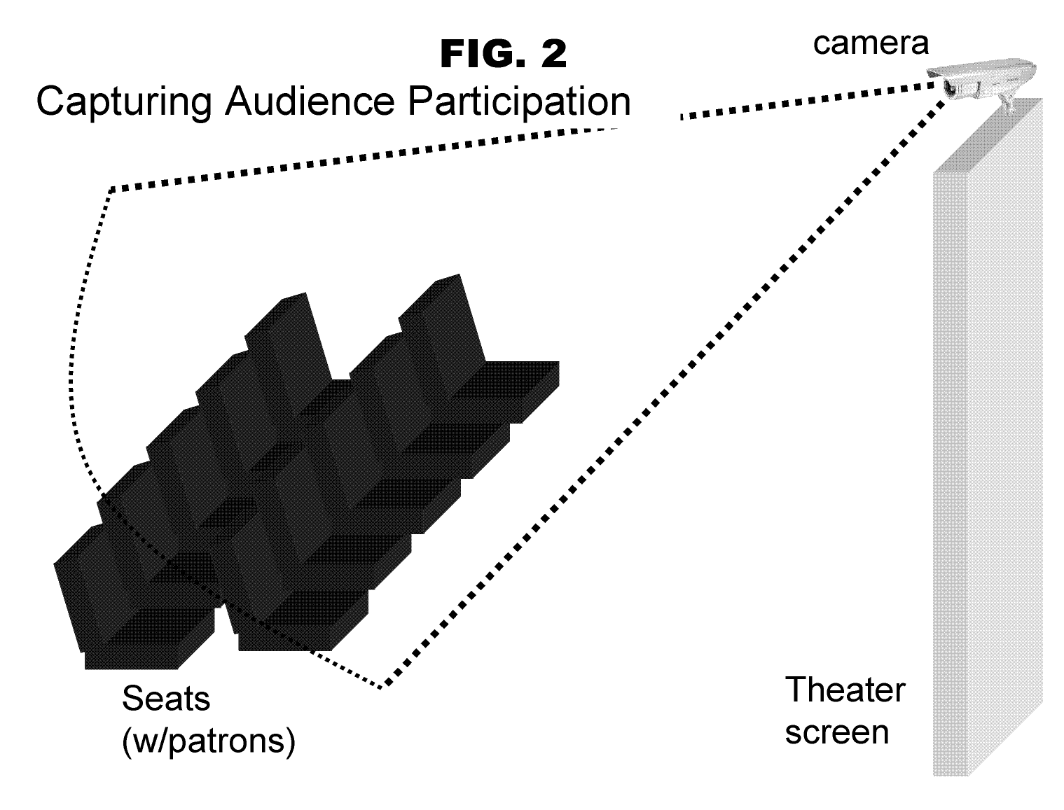

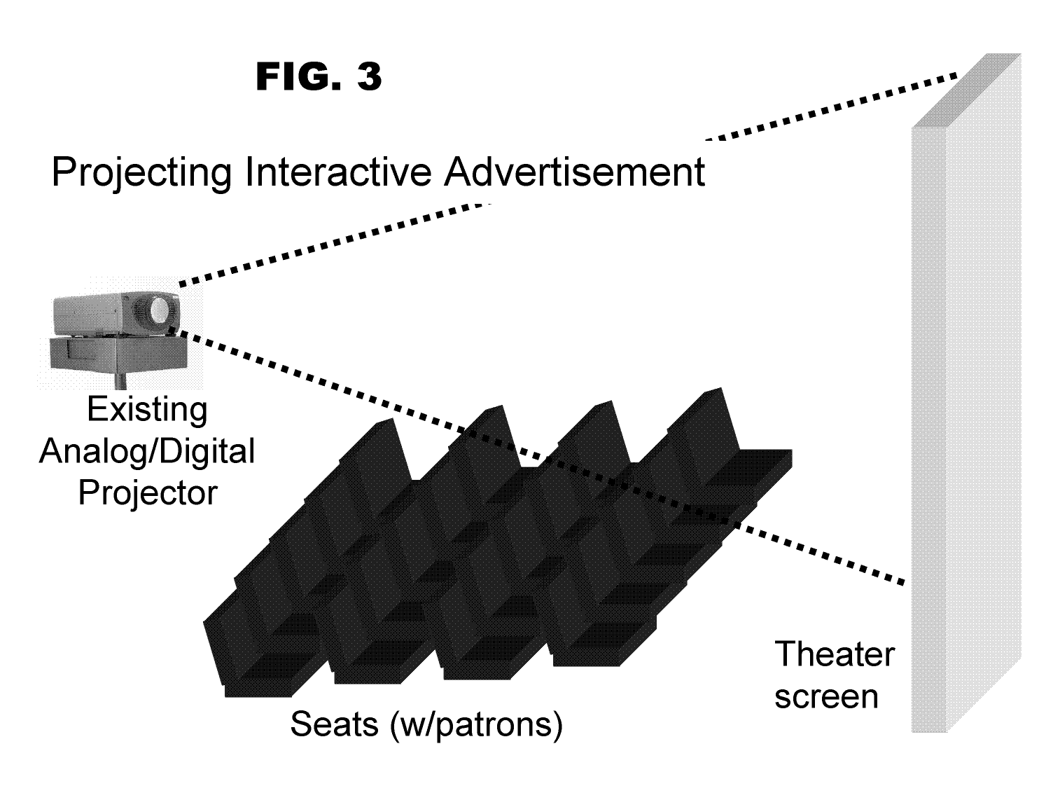

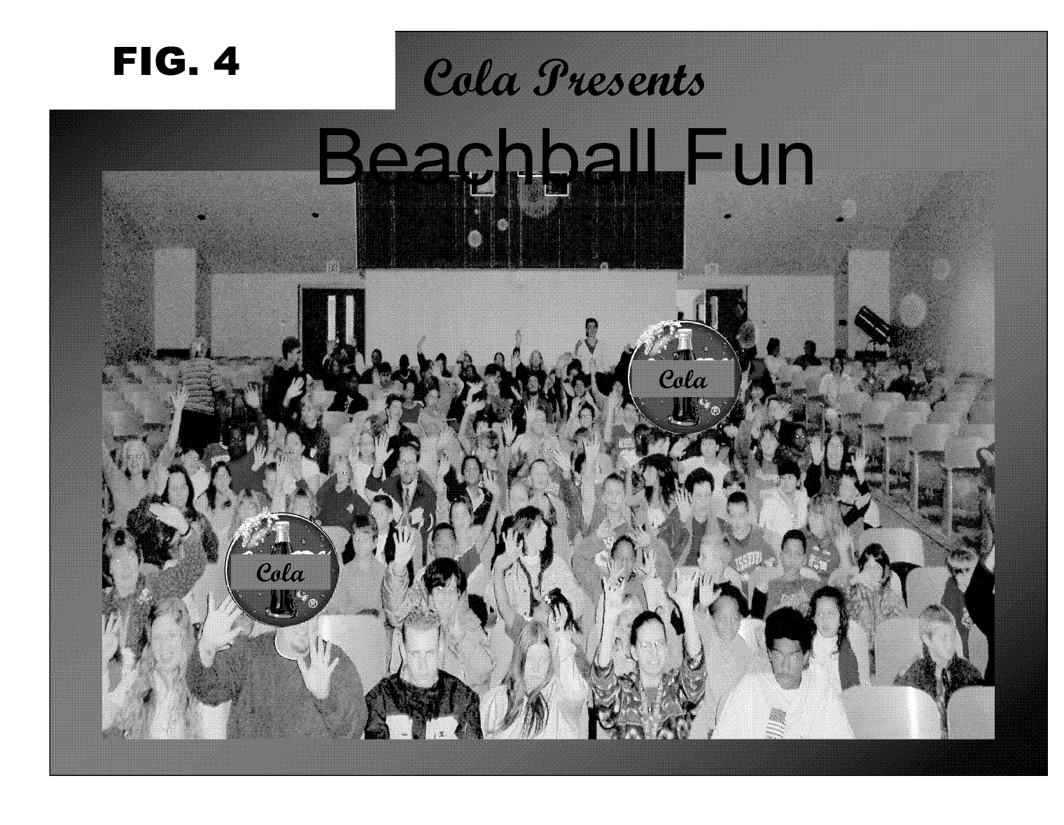

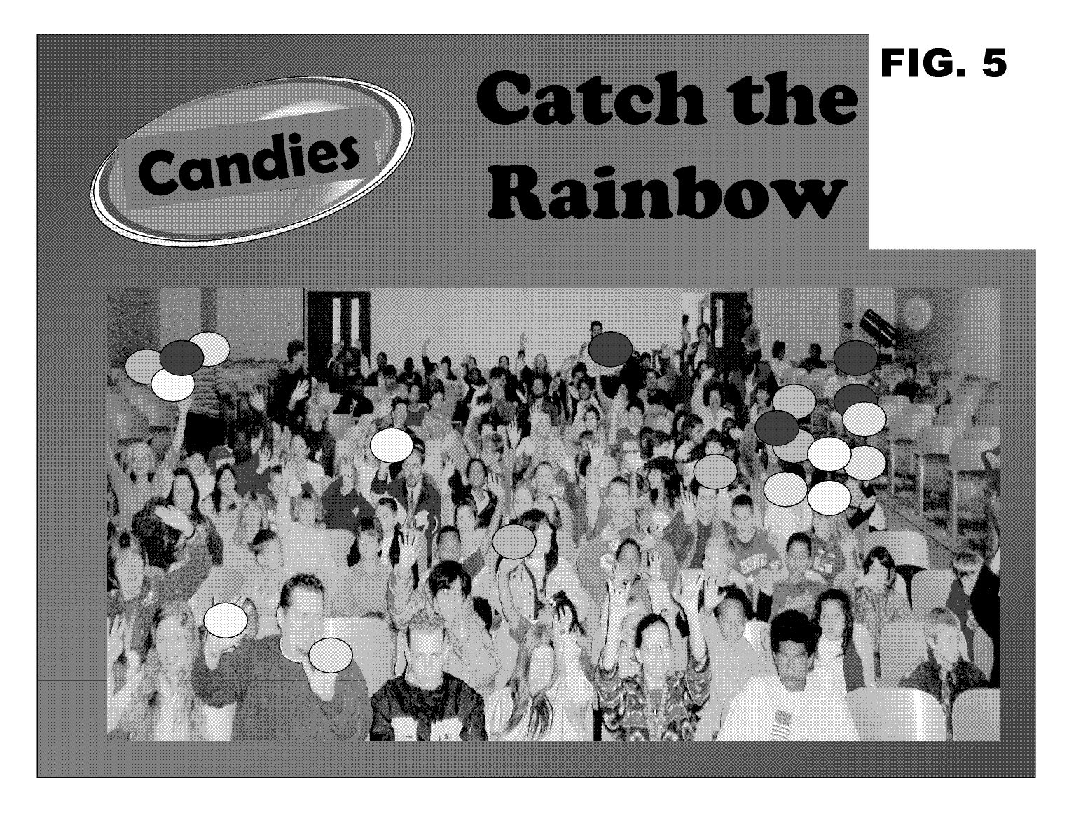

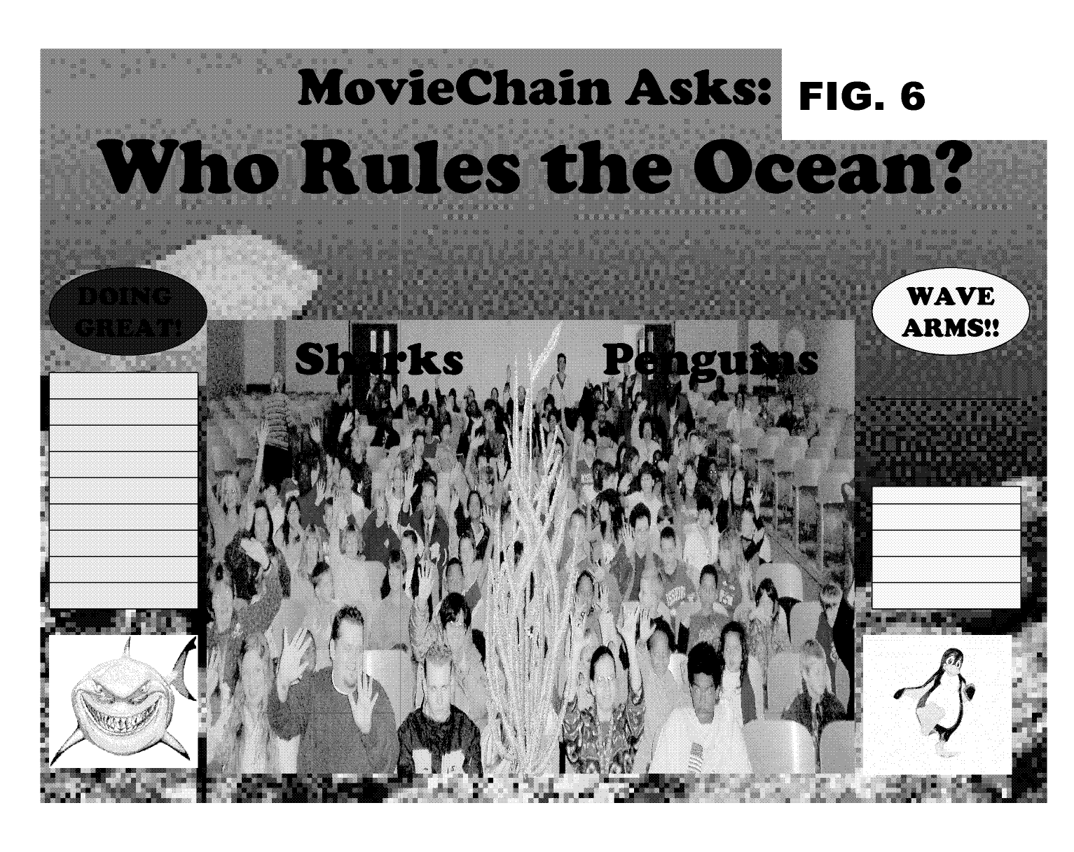

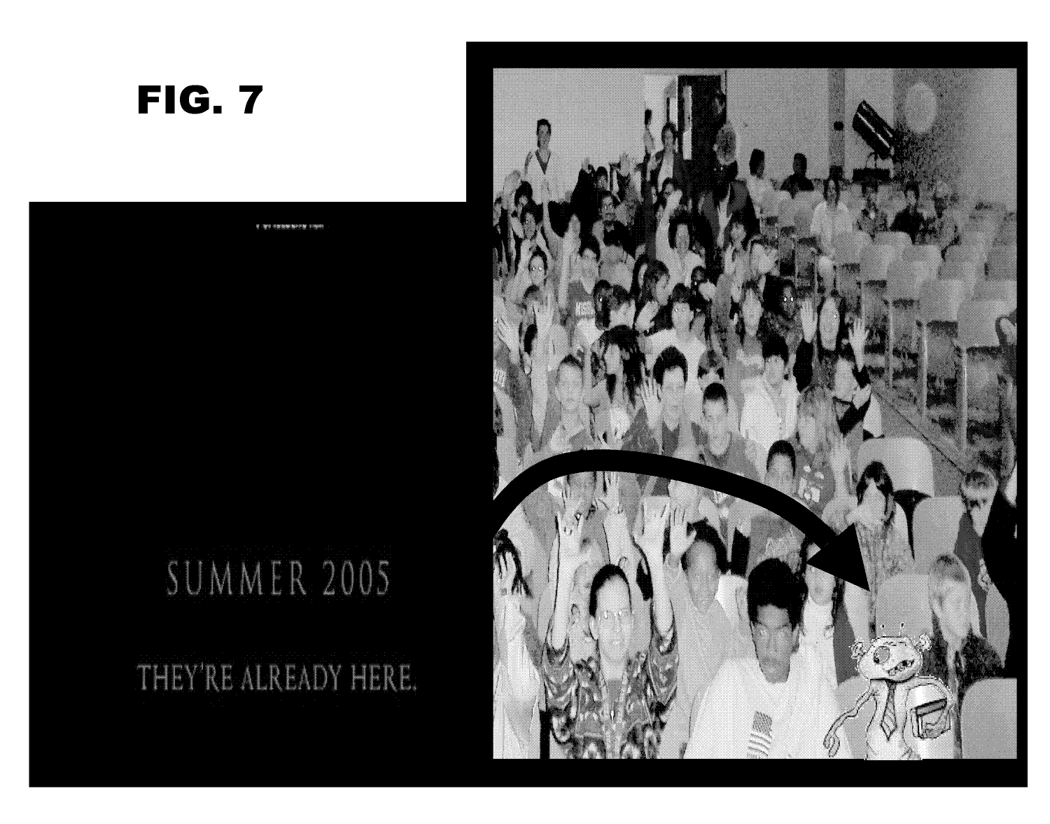

### DESCRIPTION OF THE INVENTION

An embodiment of the invention is an interactive advertisement and entertainment system for public or private movie theaters (cinemas) or venues with large screens and an audience directly in front of, and viewing, the screens.

The system utilizes a combination of video technologies to allow patrons in the audience to see themselves onscreen and “interact” with virtual animated or non-animated objects or characters.

An embodiment of the invention includes:

One or more video cameras (analog or digital), mounted on or beside the screen or in other places in the theater and aimed at the audience;

Computational hardware (e.g. one or more PCs), including appropriate hardware to capture one or more video streams coming from the cameras and hardware to output video streams to digital or analog theater projection systems;

Image processing or computer vision based software that processes and analyzes the incoming video images/streams, wherein the processing:
Includes finding locations of audience members;
Includes detecting motion of audience members;
Includes finding outlines (contours) of audience members; and,
Includes detecting and tracking faces, hands, components of audience members;

Image processing or computer vision based software that generates overlay content based on analysis of original video streams, which:
Synthesizes static or animated graphic borders, objects, or other virtual content based on audience location, motion, or action; and,
Combines original video streams of audience, in whole or in part, with overlay content;

One or more types of theater projection system capable of projecting real-time video content; and,

(Potentially) Additional lighting sources placed around theater (with visible or invisible lighting).

An embodiment of the invention works by:

Capturing audience existence or behavior using video cameras;

Importing video stream(s) from camera(s), in real time or near real time, to a computer running custom image processing software;

Analyzing audience location, movement, and related characteristics using software containing image processing algorithms.

Combining the analysis information, original video streams, and “video game” like interactive content to form a new combined video signal for projection;

Generating a new video signal, and projecting this video signal onto the theater screen; and,

Repeating this sequence of events so as to use the analyzed audience behavior to effect changes in the interactive content, thus forming a real-time interactive “game”.

Interactive content may or may not contain logos, taglines, company names, company colors, trademarked or copy written sound or images advertising a specific brand, entity, individual, event, or object.

This system would be used prior to or after the projection of a feature presentation at a cinema, or in conjunction with other content at the entertainment venue.

A business process to be used with the above includes:

The interaction of three or four classes of business entity; a technology developer (“tech”), one or more advertising agencies (“ad”), one or more cinema/theater owners (“theater”), and one or more entities wishing to advertise (“client”);

The ability to lease or sell interactive advertising systems to entertainment venues (e.g. theater owners);

The ability to install and maintain interactive advertising systems by one or more entities (e.g. tech, theater);

The ability to develop or improve interactive software “modules” for use with the interactive advertising system;

The ability to “brand” interactive software modules with advertising content through addition or modification (e.g. addition of appropriate art, interaction modes that reflect something unique about product);

The ability to distribute new or updated software modules to deployed interactive advertising systems;

The ability to license software modules and related development services to advertisers (clients) either with or without advertising agencies (ad);

The ability for advertisers to license existing software modules and have them customized with appropriate content;

The ability for advertisers to contract for the development of new or additional software modules for use with the interactive advertising system; and,

The ability of entertainment venue owners to display branded software modules on the interactive advertisement system to the general public in exchange for payment.

In one embodiment of the invention:

“Tech” company leases and installs interactive entertainment systems to theaters at low cost;

“Ad” company promotes and sells “branded” software modules to corporate or other advertisers (“client) for use with interactive advertising system in entertainment venues, and receives commission based payment for this promotion/sale;

“Tech” company is contracted by “Ad” company and “Client” to customize, brand module(s);

“Tech” or “Ad” company distributes interactive advertisements to deployed systems; and,

“Theater” owners are paid by Ad company each time they execute interactive advertisement. Payment is either flat rate or scaled based on number of tickets sold for that performance.

I claim:

1. A system comprising:
One or more video cameras (analog or digital), mounted on or beside the screen or in other places in the theater and aimed at the audience;
Computational hardware, including appropriate hardware to capture one or more video streams coming from the cameras and hardware to output video streams to digital or analog theater projection systems;
Image processing or computer vision based software that processes and analyzes the incoming video images/streams, wherein the processing:
Includes finding locations of audience members;
Includes detecting motion of audience members;
Includes finding outlines (contours) of audience members; and,
Includes detecting and tracking faces, hands, components of audience members;
Image processing or computer vision based software that generates overlay content based on analysis of original video streams, which:
Synthesizes static or animated graphic borders, objects, or other virtual content based on audience location, motion, or action; and,
Combines original video streams of audience, in whole or in part, with overlay content; and,
One or more types of theater projection system capable of projecting real-time video content.
